(19) United States
(12) Patent Application Publication
(10) Pub. No.: US 2019/0161999 A1
(43) Pub. Date: May 30, 2019

(54) DEVICE FOR DECELERATING THE MOVEMENT OF A WEAR DEVICE

(71) Applicant: WITTE Automotive GmbH, Velbert (DE)

(72) Inventors: Markus Herdering, Bochum (DE); Zdenek Slovan, Plzen (CZ)

(21) Appl. No.: 16/317,026

(22) PCT Filed: Jul. 5, 2017
(86) PCT No.: PCT/EP2017/066731

§ 371 Date: Jan. 10, 2019

(30) Foreign Application Priority Data
Jul. 11, 2016 (DE) 10 2016 112 662.4

(51) Int. Cl. E05C 17/00; E05C 17/20

(52) U.S. Cl. CPC E05C 17/003; E05Y 2900/531; E05Y 2201/21; E05C 17/203

(57) ABSTRACT

The invention relates to a device for decelerating the movement of a wear device, in particular of a motor vehicle, having a catch strap for limiting the movement of the wear device, having at least one brake lever, which is mounted about a deflection axis such that the brake lever can be deflected, and which has an actuating section and a clamping section, which can be deflected in the direction of the catch strap, and a counter bearing which, together with the clamping section, serves to clamp the catch strap.

The present invention relates to an apparatus for braking the movement of a closing device, in particular of a motor vehicle, having a catch strap for limiting the movement of the closing device.

Catch straps serve to limit the movement of a closing device such as a side door, a tailgate, or a hood of a motor vehicle and thus define a maximum open position of the closing device. There is sometimes the desire to prematurely brake the movement of the closing device, i.e. before the maximum open position has been reached, to avoid a collision of the closing device with an object located in an opening region of the closing device, for example a wall or a further motor vehicle.

Apparatus for braking the movement of a closing device are generally known. Fluidic systems are, for example, used in this respect in which a movement of the closing device is braked by means of hydraulic, electrorheological or magnetorheological fluids or the movement of the closing device is mechanically braked, for example in that a brake block is pressed toward the catch strap by a helical compression spring.

Such apparatus are as rule expensive, have a complex construction and/or can be vulnerable with respect to environmental influences.

It is an object of the invention to provide a less expensive alternative to the previous apparatus that is moreover characterized by a more compact construction shape and by increased functional security.

The object is satisfied by an apparatus having the features of claim 1. The apparatus in accordance with the invention for braking a closing device, in particular of a motor vehicle, comprises a catch strap for limiting the movement of the closing device, at least one brake lever that is deflectably supported about a deflection axis and that has an actuation section and a clamping section that is deflectable in the direction towards the catch strap, and a counter-support that serves together with the clamping section for the clamping of the catch strap.

It is the general idea underlying the invention to achieve the braking effect, unlike in the prior art, not by fluidic systems or by a simple exertion of a spring force on the catch strap, but rather by means of a lever mechanism. In this respect, a favorable leverage ratio can be provided by the use of a brake lever deflectably supported about a deflection axis such that an effective braking effect is also achieved with a small force expenditure. The advantage results as a consequence of the smaller force expenditure that an apparatus of smaller dimensions is sufficient to effectively brake the closing device. A more compact construction of the apparatus is in particular of advantage to the extent that only a small available space is typically provided in closing devices, in particular in the side door of a motor vehicle.

Advantageous embodiments of the invention can be seen from the dependent claims, from the description and from the drawings.

It is generally irrelevant whether the brake lever is a unilateral or bilateral brake lever, i.e. whether the actuation section and the clamping section are arranged with respect to the deflection axis on the same side of the deflection axis or on different sides of the deflection axis.

The actuation section advantageously has a first spacing from the deflection axis and the clamping section has a second spacing from the deflection axis, with the first spacing and the second spacing being able to differ. If the actuation section and the clamping section are located on different sides of the deflection axis, the first and second spacings will also differ when the amount of the first spacing is the same as the amount of the second spacing.

A particularly favorable leverage ratio, i.e. a particularly small force expenditure for braking the movement of a closing device, can be achieved if the first spacing is larger than the second spacing.

A drive, in particular a bidirectional drive, is preferably provided for the actuation of the actuation section. An electric drive such as an electric motor can in particular be used for this purpose. In general, however, different kinds of drive are also possible such as fluidic actuators. It is moreover also conceivable to deflect the brake lever magnetically, for example by means of an electromagnet. It is understood that the brake lever has to comprise a magnetizable material for this purpose.

The more favorable the leverage ratio is selected, the smaller the drive can be dimensioned, which not only has a positive effect on the construction size of the apparatus, but also on the power consumption of the drive.

To transmit a movement, in particular a rotary movement, of the drive to the brake lever, a transmission, in particular a spindle transmission, can be interconnected between the drive and the brake lever.

A spring can furthermore be provided that supports the drive in the deflection of the brake lever in the direction towards the catch strap. The spring in other words exerts an additional spring force on the brake lever and thus increases the braking effect of the brake lever. Due to the support of the drive by the spring, the dimensioning and the power consumption of the drive can advantageously be reduced even further, whereby the construction of the apparatus can be designed as even more compact.

On the use of a bidirectional drive, the spring supports the drive, as already mentioned, in the deflection of the brake lever in the direction towards the catch strap, whereas a return force of the spring is overcome by a force of the drive when the brake lever is deflected away from the catch strap by the drive. It is understood that the force applied by the drive has to be greater than the return force of the spring.

In accordance with an embodiment, the spring acts on the transmission. In this respect, the transmission can be a spindle transmission and the spring can be a torsion spring that exerts a spring force on a spindle of the spindle transmission in a direction of rotation that effects a deflection of the brake lever in the direction towards the catch strap. The spindle is therefore preloaded in this manner and the transmission overall is set without play, with a compensation of the return force of the spring in particular taking place directly and almost without play by the force applied by the drive. A movement, in particular a rotary movement, of the drive is in other words directly converted into a deflection of the brake lever so that only a few revolutions of the drive are required to deflect the brake lever, whereby the response time of the apparatus is substantially reduced. In addition, noise emanating from the transmission is reduced as a result of the few revolutions of the drive and of the freedom from play.

The braking effect can be further increased if still further brake levers are provided beside the brake lever. In accordance with a second embodiment, the brake lever forms a first brake lever and a second brake lever having a second actuation section and a second clamping section is arranged at a side of the catch strap disposed opposite the first brake lever and is deflectably supported about a second deflection axis. Each clamping section in this respect acts as a counter-support for the respective other clamping section.

The first and second brake levers are advantageously arranged symmetrically with respect to the catch strap. The catch strap in this case so-to-say defines a mirror plane, with the two brake levers being arranged mirror-symmetrically at both sides of the catch strap. It is understood that the first and second brake levers can, however, also be arranged asymmetrically with respect to one another.

To support the drive, the first and second brake levers can be preloaded in the direction towards the catch strap by a spring. The spring is preferably a tension spring that is arranged between the first and second brake levers and acts directly on the levers. Additionally or alternatively, at least one compression spring can be provided at a side of the first and/or second brake levers remote from the catch strap, which exerts a spring force on the first and/or second brake levers in each case in the direction towards the catch strap, that is it presses the first and/or second brake levers so-to-say in the direction towards the catch strap.

By the increase in a spacing between the spring and the first and/or second deflection axes, a force transmission of the spring on the first and/or second clamping sections can be increased with the spring force remaining the same, whereby the drive is supported even more and the power consumption of the drive can thus be further reduced so that the drive can be dimensioned as even smaller, which ultimately promotes an even more compact construction of the apparatus.

The first and second actuation sections can be actuated by means of a common drive or by means of separate drives, with a common drive or separate drives additionally being able to be provided.

The first and second brake levers are preferably simultaneously deflectable, whereby a homogeneous braking effect is promoted. A deflection of the first and second brake levers advantageously takes place symmetrically with respect to the catch strap, with in principle, however, an asymmetrical deflection of the two brake levers also being conceivable.

The first and second deflection axes can be directly or indirectly connected to one another.

In accordance with an embodiment, the catch strap and the at least one brake lever respectively have a longitudinal central axis, with the longitudinal central axis of the catch strap and the longitudinal central axis of the brake lever being aligned transversely with respect to one another.

An even more compact construction can be achieved if the catch strap and the at least one brake lever each have a longitudinal central axis and the longitudinal central axis of the catch strap and the longitudinal central axis of the brake lever are aligned at least approximately in parallel with one another.

An arm is advantageously arranged between the or each brake lever and the catch strap, with the or each arm having a contact section that can be brought into contact in a force-transmitting manner with the catch strap by a deflection of the clamping section of the respective brake lever in the direction towards the catch strap. The arm is preferably configured as a spring arm. It is, however, also conceivable that the arm is rotatably supported, that is so-to-say forms an articulated arm.

The catch strap and the or each brake lever are so-to-say decoupled by the use of an arm between the catch strap and the or each brake lever so that on the braking of a movement of the catch strap no tangential forces, i.e. no forces acting in the longitudinal direction of the catch strap, act on the brake lever and in particular on a support point of the brake lever. The advantage results from this that freedom from play of the brake lever can also be achieved over substantially the total service life of the apparatus with a simple support of the brake lever.

In general one or each contact section can also contact the catch strap in a form-fitting manner without any deflection by the respective clamping section and can thus additionally exercise the function of a guidance of the catch strap, whereby a noise development perceptible as rattling and increased wear of the apparatus can be prevented. It is understood that in this respect the or each contact section exerts a smaller force on the catch strap than if the or each contact section is deflected in the direction towards the catch strap by the respective clamping section to achieve a braking effect.

In order to improve the breaking effect, the clamping section or the contact section can additionally be coated by a material which together with a material of the catch strap has an increased friction. For example, the coating of the clamping section or of the contact section can comprise a plastic or a rubber when the catch strap is produced from metal, e.g. from steel, or has at least a metallic surface. It is also conceivable that the clamping section or the contact section has a non-slip or roughened surface.

The invention will be described in the following purely by way of example with reference to possible embodiments and to the enclosed drawings. There are shown:

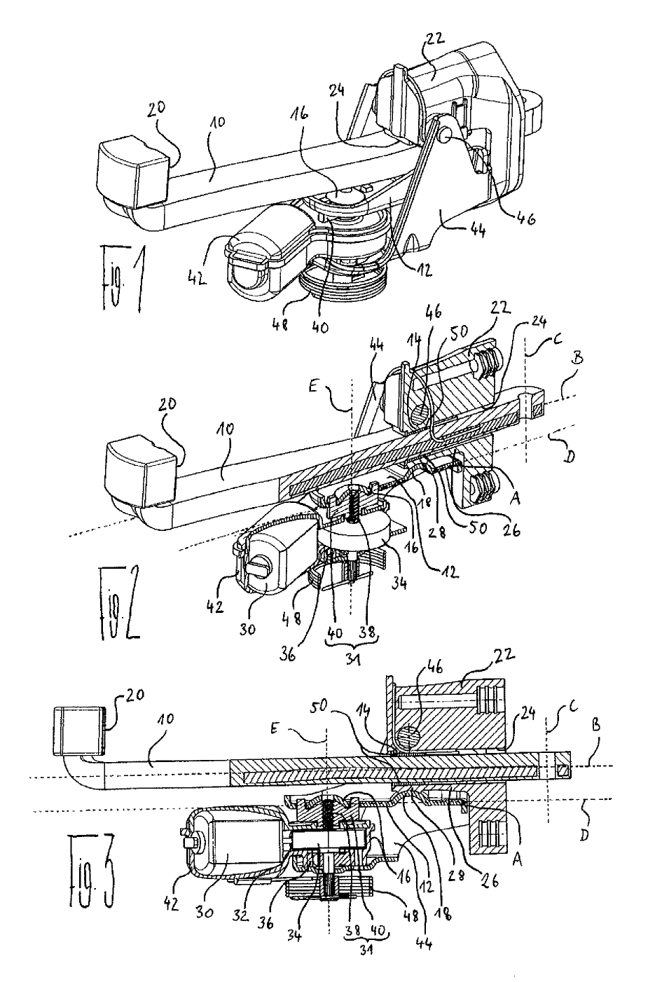

FIG. 1 a perspective view of an apparatus in accordance with the invention in accordance with a first embodiment;

FIG. 2 a perspective part-section view of the apparatus of FIG. 1;

FIG. 3 a side view of the apparatus of FIG. 2;

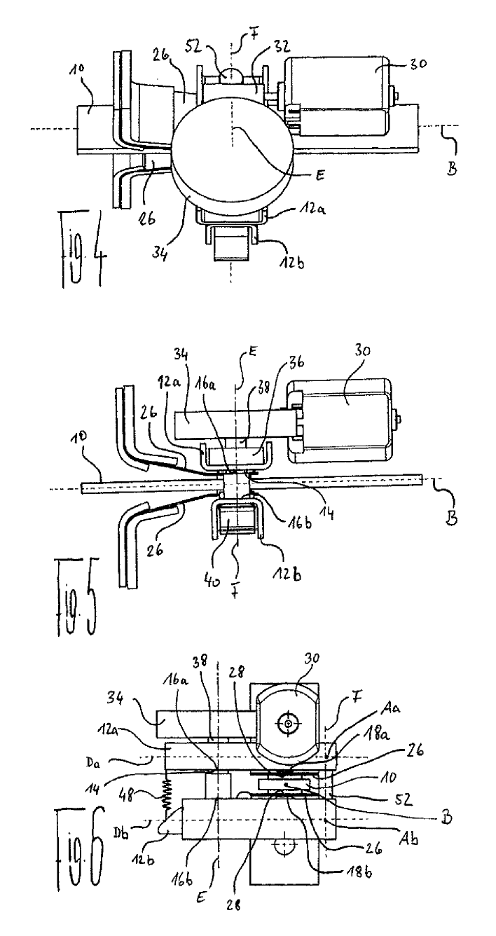

FIG. 4 a perspective view of an apparatus in accordance with the invention in accordance with a second embodiment;

FIG. 5 a first side view of the apparatus of FIG. 4; and

FIG. 6 a second side view of the apparatus of FIG. 4.

FIGS. 1 to 3 show a first embodiment of an apparatus for braking a closing device, not shown here, in particular of a side door of a motor vehicle. The apparatus comprises a catch strap 10, a brake lever 12, and a counter-support 14. The brake lever 12 is deflectably supported about a deflection axis A and has an actuation section 16 and a clamping section 18. The counter-support 14 serves together with the clamping section 18 for clamping the catch strap 10. In the present embodiment, the brake lever 12 is arranged beneath the catch strap 10 and the counter-support 14 is arranged above the catch strap 10. In principle, however, vice versa, the brake lever 12 can also be arranged above the catch strap 10 and the counter-support 14 can be arranged beneath the catch strap 10.

The catch strap 10 serves for the limiting of an opening movement of the closing device and has, for this purpose, an abutment 20 at its one end that defines a maximum open position of the closing device. At its other end, that is disposed opposite the one end in the direction of a longitudinal central axis B of the catch strap 10, the catch strap 10 is rotatably supported at a frame, not shown here, of the motor vehicle about an axis of rotation C at least approximately perpendicular to the longitudinal central axis B of the catch strap 10, in the present embodiment about an at least approximately vertical axis of rotation C.

The brake lever 12 and the counter-support 14 are attached in a fixed position to the closing device such that the brake lever 12 and the counter-support 14 move along the catch strap 10 on a movement of the closing device. It is, however, understood that, vice versa, the brake lever 12 and the counter-support 14 can also be attached in a fixed position to the frame of the motor vehicle and the catch strap 10 can be rotatably supported at the closing device.

An installation unit 22 that supports the brake lever 12 is provided for attaching the brake lever 12 to the closing device. The support point of the brake lever 12 at the installation unit 22 defines the deflection axis A.

The installation unit 22 has a passage 24 for the catch strap 10. The brake lever 12 is aligned at least approximately in parallel with the longitudinal central axis B of the catch strap 10.

The counter-support 14 for the clamping section 18 is configured in one piece with the installation unit 22 and bounds the passage 24. In general, the counter-support 14 can, however, also be a separate component that is attached to the installation unit 22 and that projects into the passage 24.

At a side of the catch strap 10 disposed opposite the counter-support 14, the passage 24 is bounded by a spring arm 26 that is arranged between the catch strap 10 and the brake lever 12. The spring arm 26 projects in one piece from the installation unit 22 and has a contact section 28. The contact section 28 is concavely shaped on a side remote from the catch strap 10 and is in engagement with the clamping section 18 that for this purpose is convexly arched in the direction towards the contact section 28.

A drive 30 that is configured in the form of an electric motor here is provided for actuating the actuation section 16 of the brake lever 12. In addition, a transmission, more exactly a spindle transmission 31, is interconnected between the drive 30 and the actuation section 14. Specifically, a rotary movement of the drive 30 is transmitted via a worm shaft 32 to a worm gear 34. The worm gear 34 is in turn rotationally fixedly attached to a spindle 38 supported by a ball bearing 36. A rotation of the worm gear 34 thus effects a rotation of the spindle 38 about a spindle axis E, whereby a spindle nut 40 attached to the actuation section 16 is traveled relative to the spindle 38 along the spindle axis E and deflects the actuation section 14.

As can be recognized with reference to FIGS. 1 to 3, the deflection axis A of the brake lever 12 that is perpendicular to the plane of the paper in FIG. 3 and the spindle axis E that extends in parallel with the plane of the paper in FIG. 3 are aligned approximately perpendicular to one another.

The drive 30 and the transmission are advantageously protected from contaminants and/or moisture in a housing 42. A holder 44 that is attached to the installation unit 22 via a pin 46 is provided for fastening the housing 42 to the installation unit 22.

For supporting the drive 30 in the deflection of the brake lever 12 in the direction towards the catch strap 10, a spring 48 is provided that is here configured in the form of a torsion spring 48, in particular of a leg spring, whose one leg is fastened to the spindle 38 and whose other leg is fastened to the housing 42. In this respect, the spring 48 is preloaded such that the return force of the spring 48 supports a rotation of the spindle 38 in a direction of rotation in which the brake lever 12 is deflected in the direction towards the catch strap 10.

In general, the leg of the spring 48 that is not attached to the spindle 38 can also be fastened elsewhere at the housing 42 as long as the spring 48 supports a rotation of the spindle 38 in a direction deflecting the brake lever 12 in the direction towards the catch strap 10.

As can be recognized with reference to FIGS. 2 and 3, the actuation section 16 has a greater spacing from the deflection axis A than the clamping section 18. As a result of this, a smaller force expenditure at the actuation section 18 allows for a higher force to be transmitted to the clamping section 18 and thus to the contact section 28, whereby a particularly effective braking effect is achieved.

To increase the braking effect of the apparatus even further, the counter-support 14 and/or the contact section 28 can each be provided with a friction lining 50. By way of example, if the catch strap 10 is produced from a metal such as steel, the counter-support 14 and/or the contact section 28 can be coated with plastic or rubber or with a plastic-like or rubber-like material for increasing the friction between the catch strap 10 and the counter-support 14 and/or the contact section 28.

A movement of the actuation section 16 of the brake lever 12 in the direction towards the catch strap 10 caused by the drive 30 has the effect that the clamping section 18 is deflected in the direction towards the catch strap 10, whereby the spring arm 26 is also deflected in the direction towards the catch strap 10. The contact section 28 of the spring arm 26 thereby comes into contact in a force-fitting manner with the catch strap 10, with the counter-support 14 counteracting a deflection of the catch strap 10 and likewise coming into contact in a force-fitting manner with the catch strap 10 so that the catch strap 10 is clamped between the counter-support 14 and the spring arm 26. All in all, a movement of the catch strap 10 and ultimately the movement of the closing device are hereby braked.

FIGS. 4 to 6 show a second embodiment of an apparatus for braking a closing device. The apparatus comprises a catch strap 10, a first brake lever 12a that is deflectably supported about a first deflection axis Aa and that has a first actuation section 16a and a first clamping section 18a as well as a second brake lever 12b that is deflectably supported about a second deflection axis Ab and that has a second actuation section 16b and a second clamping section 18b.

The first deflection axis Aa of the first brake lever 12a and the second deflection axis Ab of the second brake lever 12b are connected to one another via a common web 52 whose longitudinal central axis F is aligned at least approximately perpendicular to the first and second deflection axes Aa, Ab (FIG. 6).

As can in particular be recognized with reference to FIG. 5, the first and second brake levers 12a, 12b each have a U-shaped cross-section, whereby a higher stiffness of the brake levers 12a, 12b is achieved. In principle, however, different suitable cross-sectional shapes are also conceivable.

The catch strap 10 extends between the two clamping sections 18a, 18b, with a longitudinal central axis B of the catch strap 10 being aligned at least approximately at a right angle to a longitudinal central axis Da of the first brake lever 12a and to a longitudinal central axis Db of the second brake lever 12b (FIGS. 5 and 6).

A respective spring arm 26 that is aligned at least approximately in parallel with the longitudinal central axis B of the catch strap 10 is arranged between the catch strap 10 and each clamping section 18a, 18b. Each spring arm 26 has a contact section 28 that can be coated with a suitable material to increase the friction.

In a similar manner to the first embodiment, a drive 30 is provided, in the form of an electric motor here, for actuating the actuation sections 16a, 16b. A rotary movement of the drive 30 is transmitted via a worm shaft 32 and via a worm gear 34 (FIG. 4) to a spindle 38 rotatably supported in a ball bearing 36 (FIGS. 5 and 6) so that the rotary movement of the drive 30 is converted into a rotary movement of the spindle 38 about its spindle axis E. A spindle nut 40 seated on the spindle 38 and attached to the actuation section 16b of the second brake lever 12b is traveled relative to the spindle 38 along the spindle axis E by the rotation of the spindle 38 and the actuation section 16b of the second brake lever 12b and the contact section 28 are deflected.

In the embodiment shown, the first brake lever 12a is supported upwardly against the ball bearing 36, i.e. the first brake lever 12a acts as a substantially stationary counter-support 14 for the second brake lever 12b when it is pressed against the catch strap 10.

Alternatively, however, a further spindle nut can also be attached to the first actuation section 16a and its thread is configured in an opposite sense to the thread of the spindle nut 40 attached to the second brake lever 12b so that a rotary movement of the spindle 38 in this case effects a simultaneous, but opposite, deflection of the first and second brake levers 12a, 12b.

The spindle axis E and the deflection axes Aa and Ab of the first and second brake levers 12a, 12b are aligned at least approximately perpendicular to one another.

A spring 48 shown schematically in FIG. 6 supports the drive 30 in the deflection in the direction towards the catch strap 10. A tension spring 48 that preloads the two brake levers 12a, 12b in the direction towards the catch strap 10 is preferably used for this purpose. The tension spring 48 is advantageously spaced as far apart as possible from the deflection axes Aa, Ab of the two brake levers 12a, 12b, whereby the support of the drive 30 by the spring 48 is increased. Ideally, the spring 48 is attached to the freely movable ends of the brake levers 12a, 12b remote from the deflection axes Aa, Ab.

In general, however, at least one compression spring that exerts a spring force on the respective brake level 12a, 12b in the direction towards the catch strap 10 can also be attached to a side of one or each brake lever 12a, 12b remote from the catch strap 10.

On a corresponding actuation of the two actuation sections 16a, 16b by the drive 30, the two clamping sections 18a, 18b are deflected in the direction towards the catch strap 10, whereby the respective contact sections 28 of the spring arms 26 are also deflected in the direction towards the catch strap 10 to there move into contact in a force-fitting manner with the catch strap 10 and to brake a movement of the catch strap 10 and thus of the closing device. The two clamping sections 18a, 18b in this respect act as mutual counter-supports.

### REFERENCE NUMERAL LIST

10 catch strap
12 brake lever
14 counter-support
16 actuation section
18 clamping section
20 abutment
22 installation unit
24 passage
26 spring arm
28 contact section
30 drive
31 spindle transmission
32 worm shaft
34 worm gear
36 ball bearing
38 spindle
40 spindle nut
42 housing
44 holder
46 pin
48 spring
50 friction lining
52 web
A deflection axis
B longitudinal central axis
C axis of rotation
D longitudinal central axis
E spindle axis
F longitudinal central axis

1.-16. (canceled)

17. An apparatus for braking the movement of a closing device, the apparatus comprising
a catch strap for limiting the movement of the closing device;
at least one brake lever that is deflectably supported about a deflection axis and that has an actuation section and a clamping section deflectable in the direction towards the catch strap; and
a counter-support that serves together with the clamping section for clamping the catch strap.

18. The apparatus in accordance with claim 17, wherein the closing device is part of a motor vehicle.

19. The apparatus in accordance with claim 17, wherein an arm is arranged between the or each brake lever and the catch strap, with the or each arm having a contact section that can be brought into contact in a force-transmitting manner with the catch strap by a deflection of the clamping section of the respective brake lever in the direction towards the catch strap.

20. The apparatus in accordance with claim 19, wherein the arm is a spring arm.

21. The apparatus in accordance with claim 17, wherein the actuation section has a first spacing from the deflection axis and the clamping section has a second spacing from the deflection axis.

22. The apparatus in accordance with claim 21, wherein the first spacing is larger than the second spacing.

23. The apparatus in accordance with claim 17, further comprising a drive for the actuation of the actuation section.

24. The apparatus in accordance with claim 23, wherein the drive is an electric drive.

25. The apparatus in accordance with claim 23, wherein a transmission is interconnected between the drive and the brake lever.

26. The apparatus in accordance with claim 25, wherein the transmission is a spindle transmission.

27. The apparatus in accordance with claim 23, further comprising a spring that supports the drive in a deflection of the brake lever in the direction towards the catch strap.

28. The apparatus in accordance with claim 25, wherein the spring acts on the transmission.

29. The apparatus in accordance with claim 28, wherein the transmission is a spindle transmission and the spring is a torsion spring that exerts a spring force on a spindle of the spindle transmission in a direction of rotation that effects a deflection of the brake lever in the direction towards the catch strap.

30. The apparatus in accordance with claim 17, wherein the brake lever forms a first brake lever deflectable about a first deflection axis and a second brake lever having a second actuation section and a second clamping section is arranged at a side of the catch strap disposed opposite the first brake lever and is deflectably supported about a second deflection axis.

31. The apparatus in accordance with claim 30, wherein the first and second brake levers are preloaded in the direction towards the catch strap by a spring.

32. The apparatus in accordance with claim 31, wherein the spring is a tension spring that is arranged between the first and second brake levers.

33. The apparatus in accordance with claim 30, wherein the first and second brake levers are simultaneously deflectable.

34. The apparatus in accordance with claim 30, wherein the first and second deflection axes are connected to one another.

35. The apparatus in accordance with claim 17, wherein the catch strap and the brake lever each have a longitudinal central axis, with the longitudinal central axis of the catch strap and the longitudinal central axis of the brake lever being aligned transversely to one another.

36. The apparatus in accordance with claim 17, wherein the catch strap and the brake lever each have a longitudinal central axis, with the longitudinal central axis of the catch strap and the longitudinal central axis of the brake lever being aligned at least approximately in parallel with one another.
